(19) United States
(12) Patent Application Publication
(10) Pub. No.: US 2026/0138027 A1
(43) Pub. Date: May 21, 2026

(54) ELECTRONIC DEVICE AND METHOD FOR DISPLAYING PLURALITY OF SLOTS

(71) Applicant: NCSOFT Corporation, Seoul (KR)

(72) Inventors: Boyun KANG, Seongnam-si (KR); Kyeongdae KIM, Seongnam-si (KR); Munsu KIM, Seongnam-si (KR); Taeeun KIM, Seongnam-si (KR); Junghyun LEE, Seongnam-si (KR); Joowon LEE, Seongnam-si (KR); Sunggoo HEO, Seongnam-si (KR)

(73) Assignee: NCSOFT Corporation, Seoul (KR)

(21) Appl. No.: 19/448,402

(22) Filed: Jan. 14, 2026

Related U.S. Application Data
(63) Continuation of application No. PCT/KR2023/013543, filed on Sep. 8, 2023.

(51) Int. Cl. A63F 13/63; A63F 13/2145; G06F 3/0486; G06F 3/0488

(52) U.S. Cl. CPC A63F 13/63; A63F 13/2145; G06F 3/0486; G06F 3/0488

(57) ABSTRACT

There is provided an electronic device including: a display; memory storing instructions; and at least one processor operably coupled to the display and the memory. The at least one processor may be configured to, when executing the instructions: display a specified number of slots in a specified area of the display; execute, on the basis of a first input, at least one of functions assigned to the specified number of slots; change slots of a first group among the specified number of slots on the basis of a second input; keep displaying slots of a second group, different from the slots of the first group, in the specified area; and change, on the basis of a third input, the number of slots of the first group to be changed by the second input.

### CROSS-REFERENCE TO RELATED APPLICATION

This application is a continuation of International Application No. PCT/KR2023/013543, filed on Sep. 8, 2023 the disclosure of which is incorporated by reference herein in its entirety.

### BACKGROUND

### 1. Field

Various embodiments described herein relate to an electronic device and a method for displaying a plurality of slots.

### 2. Description of Related Art

In a virtual space in a game application, a player character (PC) corresponding to a user of an electronic device may own an item or cast a skill. The electronic device may display slots for use of the item and/or casting of the skill. The slots may be overlappingly displayed on the virtual space. The user of the electronic device may perform use of the item and/or casting of the skill through the PC, based on an input to a slot.

A user of an electronic device may allocate a function related to items and skills to a slot displayed on a screen for displaying a virtual space in a game. As the number of the items and the skills in the game increases, functions allocated to slots may overlap. When the functions allocated to the slots overlap, inconvenience in operation of PC is caused as well as limitations of the game environment itself, such as a display overload or other difficulty in displaying and/or handling too many slots.

The technical problems to be achieved in this document are not limited to those described above, and other technical problems not mentioned herein will be clearly understood by those having ordinary knowledge in the art to which the present disclosure belongs, from the following description.

### SUMMARY

There is provided an electronic device including: a display; memory storing instructions; and at least one processor operably coupled to the display and the memory, wherein the at least one processor, when executing the instructions, is configured to: display a designated number of slots within a designated area of the display; based on a first input, execute at least one of functions allocated to the designated number of slots; based on a second input, change, within the designated area, a first group of slots among the designated number of slots from a first plurality of the slots and to a second plurality of the slots, and maintain a displaying, on the display, of a second group of slots distinct from the first group of slots within the designated area both before and after changing the first group of slots from the first plurality of the slots to the second plurality of the slots; and based on a third input, change a number of slots of the first group of slots from a first number of slots to a second number of slots.

The third input may be identified by a drag input moving a divider displayed within the designated area and between the first group of slots and the second group of slots.

The at least one processor, when executing the instructions, may be further configured to: based on an input to an area within the designated area and between the first group of slots and the second group of slots, display the divider; and based on the drag input following from the input on the area, move the divider.

The third input may be identified as an input indicating to change at least one slot of the first group of slots from the first group of slots and to the second group of slots.

The at least one processor, when executing the instructions, may be further configured to: identify an input indicating the at least one slot of the first group of slots; based on identifying the input indicating the at least one slot of the first group of slots, display a visual object representing movement of the at least one slot of the first group of slots; and based on a drag input following from the input indicating the at least one slot of the first group of slots, change the at least one slot of the first group of slots to the second group of slots.

The first input may be identified based on an input of one of shortcut keys preset to ones of the designated number of slots.

One or more first functions allocated to the first group of slots may be executed based on a first type of shortcut key input of the input of the one of the shortcut keys, the one or more first functions allocated to the first group of slots may be first ones of the functions allocated to the designated number of slots, and one or more second functions allocated to the second group of slots may be executed based on a second type of shortcut key input distinct from the first type of shortcut key input, the one or more second functions allocated to the second group of slots may be second ones of the functions allocated to the designated number of slots.

The at least one processor, when executing the instructions, may be further configured to: based on the third input and on identifying the second type of shortcut key input as being input, execute at least one function allocated to the at least one slot changed from the first group of slots to the second group of slots.

The at least one processor, when executing the instructions, may be further configured to: display the first group of slots as one of a plurality of pages of the first group of slots; identify the second input while one of the plurality of pages may be displayed; and based on the second input, change the first group of slots by changing the one of the plurality of pages to another page of the plurality of pages.

The at least one processor, when executing the instructions, may be further configured to: display a first visual object representing the plurality of pages in conjunction with the first group of slots; and display a second visual object representing that the second group of slots may be in a fixed state in conjunction with the second group of slots.

There is provided a method of an electronic device, the method including: displaying a designated number of slots within a designated area of a display of the electronic device; based on a first input, executing at least one of functions allocated to the designated number of slots; based on a second input, changing, within the designated area, a first group of slots among the designated number of slots from a first plurality of the slots to a second plurality of the slots, and maintain a displaying, on the display, of a second group of slots distinct from the first group of slots within the designated area both before and after changing the first group of slots from the first plurality of the slots to the second plurality of the slots; and based on a third input, changing a number of slots of the first group of slots from a first number of slots to a second number of slots.

The third input may be identified by a drag input moving a divider displayed within the designated area and between the first group of slots and the second group of slots.

The method may further include based on an input to an area within the designated area and between the first group of slots and the second group of slots, displaying the divider; and based on the drag input following from the input on the area, moving the divider.

The third input may be identified as an input indicating to change at least one slot of the first group of slots from the first group of slots and to the second group of slots.

The method may further include identifying an input indicating the at least one slot of the first group of slots; based on identifying the input indicating the at least one slot of the first group of slots, displaying a visual object representing movement of the at least one slot of the first group of slots; and based on a drag input following from the input indicating the at least one slot of the first group of slots, changing the at least one slot of the first group of slots to the second group of slots.

The first input may be identified based on an input of one of shortcut keys present to ones of the designated number of slots.

One or more first functions allocated to the first group of slots may be executed based on a first type of shortcut key input of the input of the one of the shortcut keys, the one or more first functions allocated to the first group of slots may be ones of the functions allocated to the designated number of slots, and one or more second functions allocated to the second group of slots may be executed based on a second type of shortcut key input distinct from the first type of shortcut key input, the one or more second functions allocated to the second group of slots may be second ones of the functions allocated to the designated number of slots.

The method may further include: based on the third input and on identifying the second type of shortcut key input as being input, execute at least one function allocated to the at least one slot of the first group of slots.

The method may further include displaying the first group of slots as one of on a plurality of pages of the first group of slots; identifying the second input while one of the plurality of pages may be displayed; and based on the second input, changing the first group of slots by changing the one of the plurality of pages to another page of the plurality of pages.

There is provided a non-transitory computer readable storage media storing one or more programs, wherein the one or more programs includes instructions which, when executed by at least one processor of an electronic device with a display, cause the electronic device to: display a designated number of slots within a designated area of the display; based on a first input, execute at least one of functions allocated to the designated number of slots; based on a second input, change, within the designated area, a first group of slots among the designated number of slots from a first plurality of the slots to a second plurality of the slots, and maintain a displaying, on the display, of a second group of slots distinct from the first group of slots within the designated area both before and after changing the first group of slots from the first plurality of the slots to the second plurality of the slots; and based on a third input, change a number of slots of the first group of slots from a first number of slots to a second number of slots.

An electronic device and a method according to various embodiments can divide slots displayed in a game application into a first group of slots and a second group of slots. The electronic device and the method can change the number of the first group of slots and/or the number of the second group of slots, based on an input received from a user.

The effects that can be obtained from the present disclosure are not limited to those described above, and any other effects not mentioned herein will be clearly understood by those having ordinary knowledge in the art to which the present disclosure belongs, from the following description.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 is a block diagram for describing an electronic device and an external electronic device connected to each other based on a network;

FIG. 2 illustrates a user interface (UI) of an exemplary game application displayed on a display of an electronic device according to one or more embodiments;

FIG. 3 illustrates an example of slots displayed within a designated area according to one or more embodiments;

FIG. 4 illustrates an example of slots displayed within a designated area according to one or more embodiments;

FIGS. 5A and 5B illustrate an example of slots displayed within a designated area according to one or more embodiments; and

FIGS. 6A and 6B illustrate an example of slots displayed within a designated area according to one or more embodiments.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, a server, or a home appliance. According to one or more embodiments of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with the present document, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

Various embodiments as set forth herein may be implemented as software (e.g., the program) including one or more instructions that are stored in a storage medium that is readable by a machine (e.g., the electronic device). For example, a processor of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to one or more embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™ or AppStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

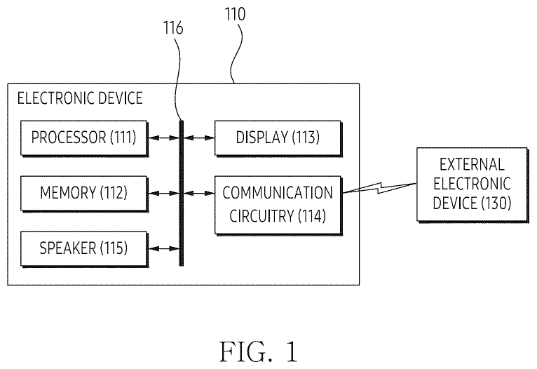

FIG. 1 is a block diagram for describing an electronic device and an external electronic device connected to each other based on a network. Referring to FIG. 1, an exemplary situation in which an electronic device 110 and an external electronic device 130 are connected to each other based on a wired network and/or a wireless network is illustrated.

The wired network may include a network such as the Internet, a local area network (LAN), a wide area network (WAN), Ethernet, or a combination thereof. The wireless network may include a network such as long-term evolution (LTE), 5G new radio (NR), wireless fidelity (WiFi), ZigBee, near field communication (NFC), Bluetooth, Bluetooth low energy (BLE), or a combination thereof. Although the electronic device 110 and the external electronic device 130 are illustrated to be directly connected, the electronic device 110 and the external electronic device 130 may be indirectly connected through one or more routers and/or an Access Point (AP).

In various embodiments, the electronic device 110 may be a terminal owned by different users. In various embodiments, the electronic device 110 may be a client device for users playing an online game. The terminal may include, for example, a personal computer such as a laptop and a desktop, a smartphone, a smartpad, a tablet personal computer, and smart accessories such as a smartwatch and a Head-Mounted Device (HMD). Users of the electronic device 110 may be subscribers of a service provided by the external electronic device 130.

In various embodiments, the external electronic device 130 may include a server of a service provider. The server may include one or more personal computers and/or workstations. In one or more embodiments, the external electronic device 130 may be at least one server that provides a service for the online game. For example, the external electronic device 130 may include a game server, a database that stores user information of the online game, and a data service that stores data for execution of the online game. For example, within the database, the data for the execution of the online game may be stored as a record and/or a table distinguished for each subscriber of the online game. For example, the record may include content (e.g., data associated with a virtual item described herein, for example) to be exclusively provided to the subscriber through the online game. Data associated with the virtual item may correspond, for example, to at least one parameter used in the execution of the game, such as an owner, a price, and a layout.

Referring to FIG. 1, the electronic device 110 according to one or more embodiments may include a processor 111, memory 112, a display 113, communication circuitry 114, and a speaker 115. The processor 111, the memory 112, the display 113, the communication circuitry 114, and the speaker 115 may be electronically and/or operably coupled with each other by an electronic component such as a communication bus 116. Although illustrated based on different blocks, one or more embodiments are not limited thereto, and a portion (e.g., at least a portion of the processor 111, the memory 112, and the communication circuitry 114) of hardware components illustrated in FIG. 1 may be included in a single integrated circuit (SIC), such as a System on a Chip (SoC). A type and/or the number of the hardware components included in the electronic device 110 is not limited as illustrated in FIG. 1. For example, the electronic device 110 may include only a portion of the hardware components illustrated in FIG. 1.

The processor 111 of the electronic device 110 according to one or more embodiments may include a hardware component for processing data based on one or more instructions. The hardware components for processing data may include, for example, an Arithmetic and Logic Unit (ALU), a Floating Point Unit (FPU), a Field Programmable Gate Array (FPGA), and/or a Central Processing Unit (CPU). The number of processors 111 may be one or more. For example, the processor 111 may have a structure of a multi-core processor 111, such as a dual core, a quad core, or a hexa core.

The memory 112 of the electronic device 110 according to one or more embodiments may include a hardware component for storing data and/or instructions inputted to and/or outputted from the processor 111. The memory 112 may include, for example, volatile memory such as random-access memory (RAM) and/or non-volatile memory such as a read-only memory (ROM). The volatile memory may include, for example, at least one of dynamic RAM (DRAM), static RAM (SRAM), cache RAM, and pseudo SRAM (PSRAM). The non-volatile memory may include, for example, at least one of a Programmable ROM (PROM), an Erasable PROM (EPROM), an Electrically Erasable PROM (EEPROM), flash memory, a hard disk, a compact disk, and an embedded Multi Media Card (eMMC).

In the memory 112, one or more instructions representing an operation to be performed by the processor 111 on data may be stored. A set of instructions may be referred to as firmware, an operating system, a process, a routine, a sub-routine and/or an application. For example, the electronic device 110 and/or the processor 111 of the electronic device 110 may perform at least one of operations illustrated in the drawings described below and herein by executing a set of a plurality of instructions distributed in a form of an application. Hereinafter, an application being installed in the electronic device 110 may mean that one or more applications provided in a form of the application are stored in the memory 112 of the electronic device 110, and that the one or more applications are stored in an executable format (e.g., a file with an extension designated by an operating system of the electronic device 110) by the processor 111 of the electronic device 110.

The display 113 of the electronic device 110 according to one or more embodiments may output visualized information (e.g., at least one of UIs described below and herein) to a user. For example, the display 113 may output the visualized information to the user by being controlled by a controller such as the processor 111. The display 113 may include a Flat Panel Display (FPD) and/or electronic paper. The FPD may include a Liquid Crystal Display (LCD), a Plasma Display Panel (PDP), and/or one or more Light Emitting Diodes (LEDs). The LED may include an Organic LED (OLED).

The display 113 of the electronic device 110 according to one or more embodiments may include a sensor (e.g., a touch sensor panel (TSP)) for detecting an external object (e.g., a finger of the user) on the display 113. For example, based on the TSP, the electronic device 110 may detect the external object contacted with the display 113 or floating on the display 113. In response to detecting the external object, the electronic device 110 may execute a function related to a specific visual object corresponding to a position of the external object on the display 113 among visual objects displayed in the display 113.

The display 113 may include a panel and at least one Display Driver Integrated-Circuit (DDI). For example, in a case that the panel includes a plurality of LEDs arranged in a form of a two-dimensional matrix, the DDI may control at least one LED included in a corresponding row or column among the plurality of LEDs. The DDI controlling of the at least one LED may include an operation of adjusting luminance and/or brightness of the LEDs.

The communication circuitry 114 of the electronic device 110 according to one or more embodiments may include a hardware component for supporting transmission and/or reception of an electrical signal between the electronic device 110 and the external electronic device 130. Although only the external electronic device 130 is illustrated, one or more embodiments are not limited thereto, and for example, the electronic device 110 may communicate with other external electronic devices 130. The communication circuitry 114 may include, for example, at least one of MODEM, an antenna, and an Optic/Electronic (O/E) converter. The communication circuitry 114 may support transmission and/or reception of the electrical signal based on various types of protocols such as Ethernet, a LAN, a WAN, WiFi, Bluetooth, BLE, ZigBee, LTE, and 5G NR.

The electronic device 110 according to one or more embodiments may include an output means for outputting information in a form other than a visualized form. For example, the electronic device 110 may include the speaker 115 for outputting an acoustic signal. The number of speakers 115 included in the electronic device 110 may be one or more. The electronic device 110 may include other output means for outputting information in a form other than a visual form and an audible form. For example, the electronic device 110 may include a motor for providing haptic feedback based on physical vibration.

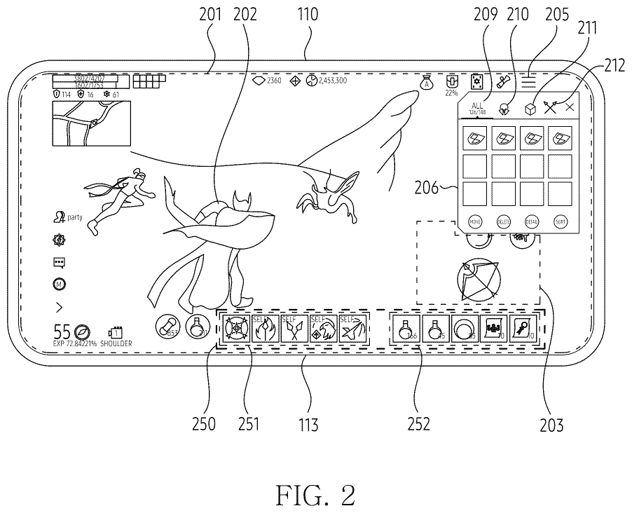

FIG. 2 illustrates UI of an exemplary game application displayed on a display of an electronic device according to one or more embodiments.

Referring to FIG. 2, UI 201 of the exemplary game application displayed on a display 113 of an electronic device 110 is illustrated. For example, the electronic device 110 may provide screens to a user in a state in which matching between the electronic device 110 and an external electronic device (e.g., the external electronic device 130 of FIG. 1) is performed. Hereinafter, a screen may mean the UI displayed in at least a portion of the display 113.

According to one or more embodiments, the UI 201 may include a virtual space displayed based on the game application, a PC 202 corresponding to the user of the electronic device 110, an icon 203 for manipulating movement of the PC 202, and an icon 205 for selecting various settings of the game application.

According to one or more embodiments, the electronic device 110 may display a plurality of slots in an area 250 set within the UI 201. For example, the plurality of slots may be configured by a designated number. As an example, the electronic device 110 may change the number of the plurality of slots based on a set value. For example, the plurality of slots may be used to perform a designated function. As an example, a first slot may be used to perform a first function. A second slot may be used to perform a second function.

According to one or more embodiments, functions may be allocated to each of the plurality of slots. For example, one of an item, a skill, and equipment may be disposed in one (hereinafter, referred to as a first slot) of the plurality of slots. In a case that an item is disposed in the first slot, the electronic device 110 may use the item based on identifying an input on the first slot. In a case that a skill is disposed in the first slot, the electronic device 110 may cast the skill based on identifying an input on the first slot. In a case that equipment is disposed in the first slot, the electronic device 110 may mount corresponding equipment to the PC 202 based on identifying an input on the first slot.

According to one or more embodiments, the electronic device 110 may display the plurality of slots in the area 250. For example, the area 250 may not be in a fixed state. According to one or more embodiments, the electronic device 110 may change a position of the area 250 based on a user input. For example, the electronic device 110 may display the area 250 on an upper end of the PC 202. For example, the electronic device 110 may display the area 250 on a left side and/or a right side of the PC 202. According to one or more embodiments, the area 250 may be configured with one or more areas. For example, a first area included in the area 250 may be displayed on the upper end of the PC 202. A second area included in the area 250 may be displayed on a lower end of the PC 202.

According to one or more embodiments, a function may be allocated to each of the plurality of slots, based on a user input. For example, the electronic device 110 may display UI 206 for indicating a list of functions that may be performed through the PC 202 by overlapping the UI 201 based on the user input. The functions that may be performed through the PC 202 may include items owned by the PC 202, skills that the PC 202 may cast, and/or equipment owned by the PC 202. The electronic device 110 may display a list of all functions that may be performed through the PC 202 within the UI 206 based on an input on an object 209. The electronic device 110 may display a list of the equipment owned by the PC 202 within the UI 206 based on an input on an object 210. The electronic device 110 may display a list of the items owned by the PC 202 based on an input on an object 211. The electronic device 110 may display a list of the skills that the PC 202 may cast based on an input on an object 212.

For example, the electronic device 110 may allocate a function to each of the plurality of slots based on an input received from the user. Basically, the plurality of slots may be set as empty slots. In a case that a function is not allocated to a slot, the slot may be set to an empty slot. The electronic device 110 may allocate a portion of the functions that may be performed through the PC 202 displayed on the UI 206 to the plurality of slots. The electronic device 110 may allocate the portion of the functions that may be performed through the PC 202 displayed on the UI 206 to the plurality of slots, based on a user input.

For example, the electronic device 110 may execute at least one of the functions allocated to the plurality of slots based on an input (hereinafter, a first input) on at least one of the plurality of slots.

As an example, a function for using a designated item may be allocated to the first slot among the plurality of slots. An object representing the designated item may be displayed in the first slot. The electronic device 110 may use the designated item through the PC 202 based on an input on the first slot.

As an example, a function for using a designated skill may be allocated to the second slot among the plurality of slots. An object representing the designated skill may be displayed in the second slot. The electronic device 110 may cast the designated skill through the PC 202 based on an input on the second slot.

As an example, a function for mounting designated equipment may be allocated to a third slot among the plurality of slots. An object representing the designated equipment may be displayed in the third slot. The electronic device 110 may mount the designated equipment through the PC 202 based on an input on the third slot.

According to one or more embodiments, the plurality of slots may include a first group of slots 251 and a second group of slots 252.

For example, the first group of slots 251 may be displayed based on a plurality of pages. The first group of slots 251 may be displayed based on one of the plurality of pages. The first group of slots 251 may be slots included in the one of the plurality of pages. The electronic device 110 may change the one of the plurality of pages to another page based on an input for changing a page (e.g., a drag input in a designated direction or a swipe input in the designated direction). The electronic device 110 may change the first group of slots 251 by changing the one of the plurality of pages to the other page.

For example, the second group of slots 252 may be in a fixed state. The electronic device 110 may maintain displaying the second group of slots 252 regardless of an input (e.g., the drag input in the designated direction, or the swipe input in the designated direction) for changing a page in which the first group of slots 251 is included.

Hereinafter, a detailed operation for changing a configuration of the first group of slots 251 and the second group of slots 252 will be described.

According to one or more embodiments, the electronic device 110 may display a designated number of slots within a designated area. For example, the electronic device 110 may display the designated number of slots within the designated area of the display 113. For example, the electronic device 110 may display the designated number of slots (e.g., the plurality of slots of FIG. 2) within the designated area (e.g., the area 250 of FIG. 2) in the UI for displaying a PC 202.

For example, the designated area may be changed. The electronic device 110 may receive an input for changing a position of the designated area from the user. The electronic device 110 may change the position of the designated area based on the input.

For example, the designated number may be changed. The electronic device 110 may receive an input for changing the designated number from the user. The electronic device 110 may change the designated number based on the input. As an example, the electronic device 110 may change the number of slots displayed within the designated area based on the input.

According to one or more embodiments, the electronic device 110 may identify whether the first input is identified. For example, the first input may include an input for selecting at least one of the slots displayed within the designated area. The electronic device 110 may identify the first input based on the input for selecting the at least one of the slots displayed in the designated area. The first input may be identified by the input for selecting the at least one of the slots displayed within the designated area.

For example, in a case that the first input is identified, the electronic device 110 may execute at least one of the functions allocated to the slots. For example, the electronic device 110 may execute the at least one of the functions allocated to the slots based on identifying the first input.

For example, the electronic device 110 may identify an input on at least one of the slots as the first input. The electronic device 110 may execute the at least one of the functions allocated to the slots based on the first input. As an example, the electronic device 110 may identify an input on the first slot among the slots as the first input. The electronic device 110 may execute the first function allocated to the first slot based on the first input. As an example, the electronic device 110 may identify an input on the first slot and the second slot among the slots as the first input. The electronic device 110 may execute the first function allocated to the first slot and the second function allocated to the second slot, based on the first input.

For example, the electronic device 110 may identify an input on one slot (hereinafter, referred to as the first slot). One or more functions may be allocated to the first slot. The electronic device 110 may perform the one or more functions allocated to the first slot based on the input on the first slot. For example, functions of using a skill and using an item may be simultaneously allocated to the first slot. The electronic device 110 may use the skill and use the item through the PC 202 based on the input on the first slot.

According to one or more embodiments, the electronic device 110 may identify an input on one or more slots. For example, the electronic device 110 may identify a touch input, a click input, or a drag input on the one or more slots. As an example, the electronic device 110 may identify a multi-touch input for selecting the one or more slots. As an example, the electronic device 110 may identify the click input for sequentially selecting the one or more slots. As an example, the electronic device 110 may identify the drag input sequentially connecting the one or more slots. The electronic device 110 may sequentially and/or simultaneously execute functions allocated to the one or more slots based on the input on the one or more slots.

According to one or more embodiments, the first input may be identified based on an input on one of shortcut keys corresponding to the slots. For example, the shortcut keys may be allocated to each of the slots. For example, a key for inputting ‘1’ may be allocated as a shortcut key to the first slot of the slots. The electronic device 110 may execute a function allocated to the first slot based on identifying an input on the key for inputting ‘1’.

According to one or more embodiments, the electronic device 110 may identify whether the second input is identified. The electronic device 110 may identify whether the second input is identified based on the first input being not identified.

For example, the second input may include a drag input in the designated direction or a swipe input in the designated direction for slots displayed within the designated area. The electronic device 110 may identify the second input based on the drag input in the designated direction for the slots displayed within the designated area. The second input may be identified by the drag input in the designated direction for the slots displayed within the designated area.

For example, the second input may include a designated shortcut key input. The electronic device 110 may identify the second input based on the designated shortcut key input. The second input may be identified by the designated shortcut key input. For example, the second input may include a mouse wheel input. The electronic device 110 may identify the second input based on the mouse wheel input on the designated area.

For example, in a case that the second input is identified, the electronic device 110 may change the first group of slots among the slots displayed within the designated area and maintain the second group of slots displayed within the designated area. For example, based on identifying the second input, the electronic device 110 may change the first group of slots among the slots displayed within the designated area and maintain the second group of slots displayed within the designated area.

For example, the first group of slots may be displayed based on the plurality of pages. The first group of slots may be slots included in one of the plurality of pages. The electronic device 110 may change the one of the plurality of pages to another page based on the second input. The electronic device 110 may change the first group of slots by changing the one of the plurality of pages to the other page.

While the first group of slots are changed by the second input, the electronic device 110 may maintain displaying the second group of slots within the designated area. For example, the electronic device 110 may fix and display the second group of slots. The electronic device 110 may maintain displaying the second group of slots even when the one of the plurality of pages is changed to the other page. The electronic device 110 may maintain displaying the second group of slots so that the user may quickly execute a function frequently used.

According to one or more embodiments, after the first group of slots are changed by the second input, the electronic device 110 may execute at least one function allocated to at least one of the changed slots and the second group of slots, based on an input on the at least one of the changed slots and the second group of slots.

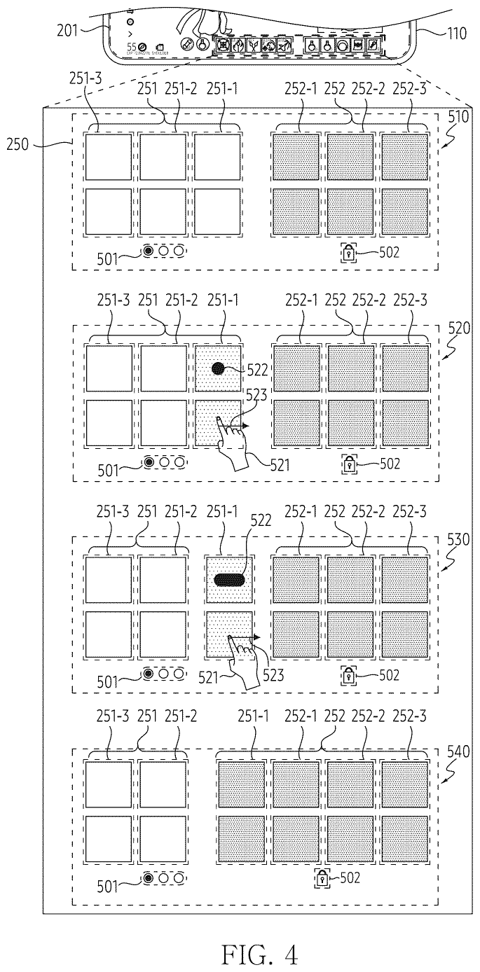

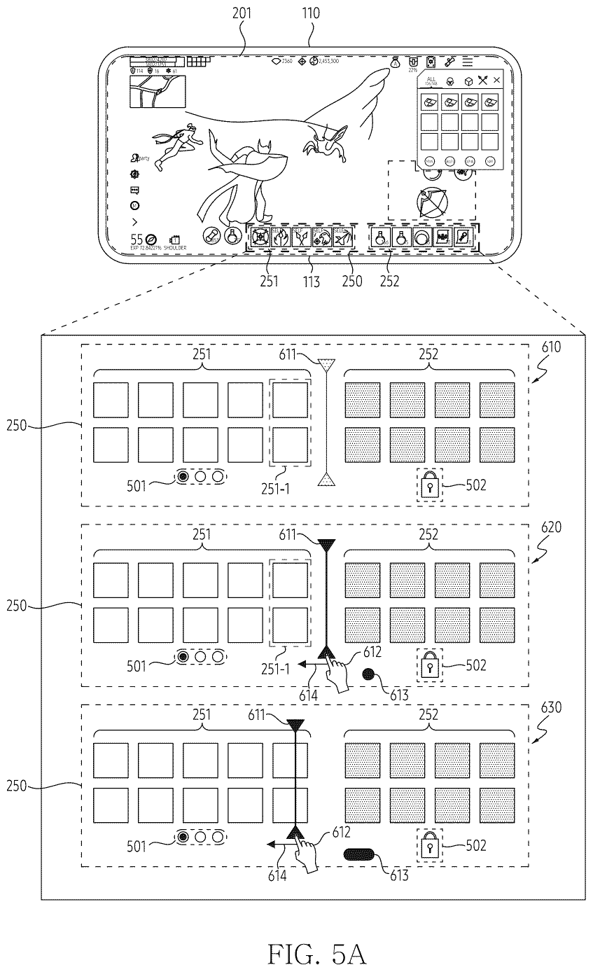

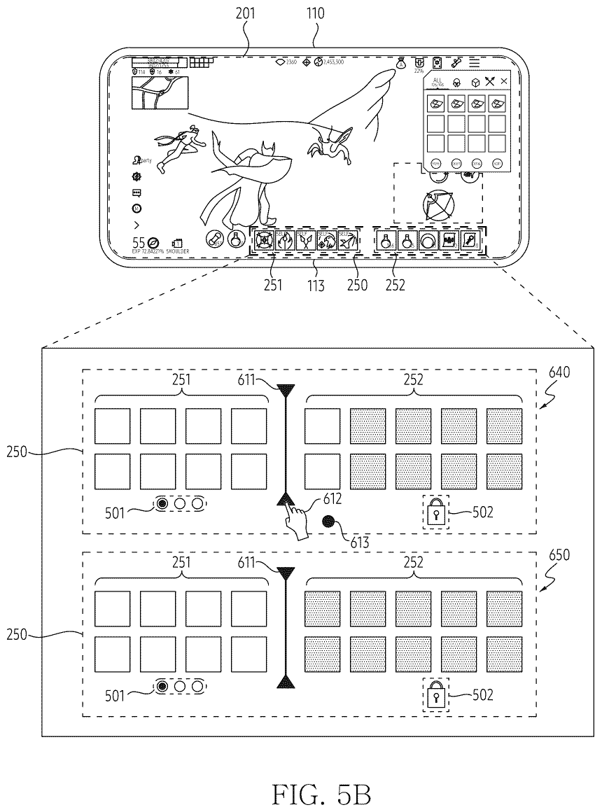

According to one or more embodiments, the electronic device 110 may identify whether a third input is identified. For example, the electronic device 110 may identify an input for moving a divider displayed between the first group of slots and the second group of slots as the third input. For example, the electronic device 110 may identify an input for changing at least one of the first group of slots to the second group as the third input. A detailed example of the third input is described with respect to FIGS. 4, 5A, and 5B for example.

For example, in a case that the third input is identified, the electronic device 110 may change the number of the first group of slots to be changed by the second input. For example, the electronic device 110 may change the number of the first group of slots to be changed by the second input based on the third input.

For example, the electronic device 110 may identify an input for changing at least one of the first group of slots to the second group. The electronic device 110 may change the number of the first group of slots based on the input. A detailed example for changing the number of the first group of slots based on the input for changing the at least one of the first group of slots to the second group is described with respect to FIG. 4 for example.

For example, the electronic device 110 may change the number of the first group of slots based on movement of the divider displayed between the first group of slots and the second group of slots. A detailed example for changing the number of the first group of slots based on the movement of the divider is described with respect to FIGS. 5A and 5B for example.

According to one or more embodiments, in a case that the third input is not identified, the electronic device 110 may maintain an operation of the PC 202. For example, the electronic device 110 may maintain the operation of the PC 202 based on the third input being not identified. For example, the electronic device 110 may maintain the operation of the PC 202 based on the first input, the second input, and the third input being not all identified. For example, the electronic device 110 may maintain the operation of the PC 202 currently being performed, based on the first input, the second input, and the third input being not all identified.

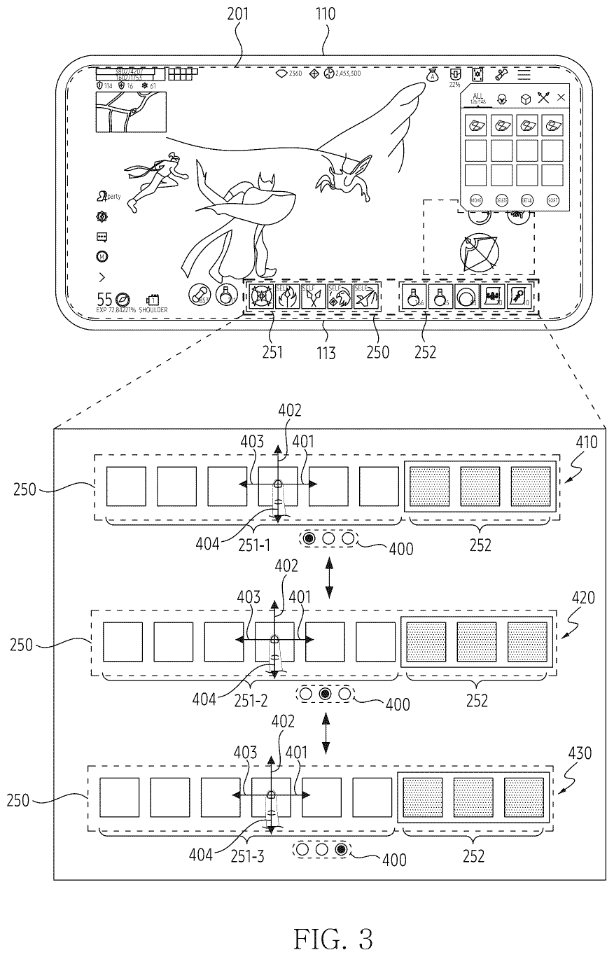

FIG. 3 illustrates an example of slots displayed within a designated area according to one or more embodiments.

Referring to FIG. 3, an electronic device 110 may display UI 201 of a game application through a display 113. For example, the UI may include a designated area 250. The electronic device 110 may display slots within the designated area 250. The slots may include a first group of slots 251 and a second group of slots 252.

For example, the first group of slots 251 may be displayed based on a plurality of pages. The first group of slots 251 may be displayed based on one of the plurality of pages. The first group of slots 251 may be slots included in the one of the plurality of pages.

As an example, the plurality of pages may include a first page, a second page, and a third page. The first group of slots 251 may include slots 251-1, slots 251-2, and slots 251-3.

The slots 251-1 of the first group of slots 251 may be included in the first page. The slots 251-2 of the first group of slots 251 may be included in the second page. The slots 251-3 of the first group of slots 251 may be included in the third page.

In a state 410, the electronic device 110 may display the slots 251-1 included in the first page among the first group of slots 251 within the designated area 250. The electronic device 110 may display the second group of slots 252 together with the slots 251-1.

For example, the electronic device 110 may display an object 400 representing a page of the first group of slots 251 within the designated area 250. As an example, in a state 410, the object 400 may represent the first page.

For example, the electronic device 110 may identify an input for changing a page within the designated area 250. The input for changing the page may be an example of the second input described in FIG. 2.

For example, the input for changing the page may include a drag input and a swipe input. For convenience of description, the input for changing the page described below and herein is described based on the swipe input, but is not limited thereto. For example, the input for changing the page may include a mouse scroll input.

According to one or more embodiments, the electronic device 110 may identify a swipe input facing a direction 401. For example, the electronic device 110 may change a state of the electronic device 110 from the state 410 to a state 420 based on the swipe input facing the direction 401. The electronic device 110 may change a page related to the first group of slots 251 from the first page to the second page, based on the swipe input facing the direction 401. The electronic device 110 may identify a swipe input facing a direction 403. For example, the electronic device 110 may change the state of the electronic device 110 from the state 410 to a state 430 based on the swipe input facing the direction 403. The electronic device 110 may change the page related to the first group of slots 251 from the first page to the third page, based on the swipe input facing the direction 403.

In the above-described embodiment, in a case that a swipe input is performed along the slots, an example of changing the page related to the first group of slots 251 has been described, but it is not limited thereto. According to one or more embodiments, the electronic device 110 may identify a swipe input facing a direction 402. For example, the electronic device 110 may change the state of the electronic device 110 from the state 410 to the state 420, based on the swipe input facing the direction 402. The electronic device 110 may change the page related to the first group of slots 251 from the first page to the second page, based on the swipe input facing the direction 402. The electronic device 110 may identify a swipe input facing a direction 404. For example, the electronic device 110 may change the state of the electronic device 110 from the state 410 to the state 430, based on the swipe input facing the direction 404. The electronic device 110 may change the page related to the first group of slots 251 from the first page to the third page, based on the swipe input facing the direction 404.

In the state 420, the electronic device 110 may display the slots 251-2 included in the second page among the first group of slots 251 within the designated area 250. The electronic device 110 may display the second group of slots 252 together with the slots 251-2.

For example, the electronic device 110 may display the object 400 representing a page of the first group of slots 251 within the designated area 250. As an example, in the state 420, the object 400 may represent the second page.

According to one or more embodiments, the electronic device 110 may identify a swipe input facing the direction 401. For example, the electronic device 110 may change a state of the electronic device 110 from the state 420 to the state 430, based on the swipe input facing the direction 401. The electronic device 110 may change a page related to the first group of slots 251 from the second page to the third page, based on the swipe input facing the direction 401. The electronic device 110 may identify a swipe input facing the direction 403. For example, the electronic device 110 may change the state of the electronic device 110 from the state 420 to the state 410, based on the swipe input facing the direction 403. The electronic device 110 may change the page related to the first group of slots 251 from the second page to the first page, based on the swipe input facing the direction 403.

According to one or more embodiments, the electronic device 110 may identify a swipe input facing the direction 402. For example, the electronic device 110 may change a state of the electronic device 110 from the state 420 to the state 430, based on the swipe input facing the direction 402. The electronic device 110 may change the page related to the first group of slots 251 from the second page to the third page, based on the swipe input facing the direction 402. The electronic device 110 may identify a swipe input facing the direction 404. For example, the electronic device 110 may change the state of the electronic device 110 from the state 420 to the state 410, based on the swipe input facing the direction 404. The electronic device 110 may change the page related to the first group of slots 251 from the second page to the first page, based on the swipe input facing the direction 404.

In the state 430, the electronic device 110 may display the slots 251-3 included in the third page among the first group of slots 251 in the designated area 250. The electronic device 110 may display the second group of slots 252 together with the slots 251-3.

For example, the electronic device 110 may display the object 400 representing a page of the first group of slots 251 in the designated area 250. As an example, in the state 430, the object 400 may represent the third page.

According to one or more embodiments, the electronic device 110 may identify a swipe input facing the direction 401. For example, the electronic device 110 may change a state of the electronic device 110 from the state 430 to the state 410, based on the swipe input facing the direction 401. The electronic device 110 may change a page related to the first group of slots 251 from the third page to the first page, based on the swipe input facing the direction 401. The electronic device 110 may identify a swipe input facing the direction 403. For example, the electronic device 110 may change the state of the electronic device 110 from the state 430 to the state 420, based on the swipe input facing the direction 403. The electronic device 110 may change the page related to the first group of slots 251 from the third page to the second page, based on the swipe input facing the direction 403.

According to one or more embodiments, the electronic device 110 may identify a swipe input facing the direction 402. For example, the electronic device 110 may change the state of the electronic device 110 from the state 430 to the state 410 based on a swipe input facing the direction 402. The electronic device 110 may change the page related to the first group of slots 251 from the third page to the first page, based on the swipe input facing the direction 402. The electronic device 110 may identify a swipe input facing the direction 404. For example, the electronic device 110 may change the state of the electronic device 110 from the state 430 to the state 420, based on the swipe input facing the direction 404. The electronic device 110 may change the page related to the first group of slots 251 from the third page to the second page, based on the swipe input facing the direction 404.

In the state 410, the state 420, and the state 430, the electronic device 110 may maintain displaying the second group of slots 252. The electronic device 110 may maintain displaying the second group of slots 252 regardless of an input for changing the page related to the first group of slots 251.

FIG. 4 illustrates an example of slots displayed within a designated area according to one or more embodiments.

Referring to FIG. 4, in a state 510, an electronic device 110 may display UI 201 of a game application through a display 113. For example, the UI may include a designated area 250. The electronic device 110 may display slots within the designated area 250. The slots may include a first group of slots 251 and a second group of slots 252.

For example, the first group of slots 251 may be displayed based on a plurality of pages. The first group of slots 251 may be displayed based on one of the plurality of pages. The first group of slots 251 may be slots included in the one of the plurality of pages. For example, the electronic device 110 may display an object 501 representing a page of the first group of slots 251 within the designated area 250.

For example, the second group of slots 252 may be in a fixed state. The electronic device 110 may maintain displaying the second group of slots 252 regardless of an input for changing a page related to the first group of slots 251. For example, the electronic device 110 may display an object 502 representing that slots of the second group of slots 252 are in the fixed state within the designated area 250.

For example, the first group of slots 251 may include slots 251-1, 251-2, and slots 251-3. The second group of slots 252 may include slots 252-1, 252-2, and slots 252-3.

In a state 520, the electronic device 110 may identify an input on at least one of the second group of slots 252. For example, the electronic device 110 may identify an input on an area corresponding to the slots 251-1. The electronic device 110 may display a visual object 522 for representing movement of the slots 251-1, based on the input. For example, the electronic device 110 may display the visual object 522 in response to a touch input on the area corresponding to the slots 251-1. The visual object 522 may be displayed by overlapping the slots 251-1. According to one or more embodiments, the visual object 522 may be displayed by being spaced apart from the slots 251-1.

The electronic device 110 may identify a drag input 521 following from the input on the area corresponding to the slots 251-1. The drag input 521 may be moved in a direction 523. The drag input 521 following from the input on the area corresponding to the slots 251-1 may be an example of the third input described in FIG. 2.

In a state 530, the electronic device 110 may change a visual object 522 based on the drag input 521 moving in the direction 523. For example, the electronic device 110 may extend the visual object 522 along the direction 523. The visual object 522 may extend along the direction 523. For example, the electronic device 110 may display the changed visual object 522 within the area corresponding to the slots 251-1.

For example, the visual object 522 may represent a direction of the drag input 521. According to one or more embodiments, the visual object 522 may be formed along the direction 523 in an arrow direction.

According to one or more embodiments, the electronic device 110 may change positions of the slots 251-1 along the drag input 521. The electronic device 110 may display the slots 251-1 by separating from the first group of slots 251. The electronic device 110 may display the slots 251-1 by separating from the first group of slots 251 to represent that the slots 251-1 are excluded from the first group of slots 251.

A state 540 may represent a state in which the drag input 521 illustrated in the state 530 is released. For convenience of explanation, in the state 540, the drag input 521 illustrated in the state 530 may be referred.

In the state 540, the electronic device 110 may move the slots 251-1 along the drag input 521. The slots 251-1 may be positioned within a designated distance from the slots 252-1 based on the drag input 521 illustrated in the state 530. The electronic device 110 may identify that the drag input 521 is released in a state that the slots 251-1 are positioned within the designated distance from the slots 252-1. For example, the electronic device 110 may identify that at least one touch input configuring the drag input 521 is released.

In a state that the slots 251-1 are positioned within the designated distance from the slots 252-1, the electronic device 110 may change the positions of the slots 251-1 so that the slots 251-1 contact the slots 252-1, based on identifying that the drag input 521 is released. For example, the electronic device 110 may change the positions of slots 251-1 within the designated distance from the slots 252-1 to contact the slots 252-1 in response to identifying that drag input 521 is released.

According to one or more embodiments, the electronic device 110 may change, based on a drag input (i.e., the drag input 521) following from an input on at least one (i.e., the slots 251-1) of the first group of slots 251, the at least one of the first group of slots 251 to the second group. The electronic device 110 may identify the drag input as a third input. The electronic device 110 may change the number of the first group of slots 251 to be changed by a second input based on the drag input.

For example, the electronic device 110 may change the slots 251-1 included in the first group of slots 251 to the second group based on the drag input 521. Based on the drag input 521, the slots 251-1 may be excluded from the first group. Based on the drag input 521, the slots 251-1 may be included in the second group of slots 252.

The electronic device 110 may change the number of the first group of slots 251 to be changed by the second input (e.g., the input for changing the page), based on the drag input 521. For example, the electronic device 110 may change the number of the first group of slots 251 from 18 to 12, based on the drag input 521. For example, the electronic device 110 may change the number of slots included in each of the plurality of pages related to the first group of slots 251 from 6 to 4, based on the drag input 521.

The electronic device 110 may change the number of the second group of slots 252 to be changed by the second input (e.g., the input for changing the page), based on the drag input 521. For example, the electronic device 110 may change the number of the second group of slots 252 from 6 to 8, based on the drag input 521.

In the above embodiment, an example in which the slots 251-1 are positioned on a left side with respect to the slots 252-1 based on the drag input 521 has been described, but it is not limited thereto. For example, the slots 251-1 may be positioned between the slots 252-1 and the slots 252-2 based on the drag input 521. For example, based on a drag input on at least one of the slots 251-2 and 251-3, the at least one of the slots 251-2 and 251-3 may be changed to the second group.

In the above embodiment, an example in which at least one of the first group of slots 251 is changed to the second group has been described, it is not limited thereto. For example, as in the above embodiment, at least one of the second group of slots 252 may be changed to the first group.

FIGS. 5A and 5B illustrate an example of slots displayed within a designated area according to one or more embodiments.

Referring to FIGS. 5A and 5B, in a state 610 to a state 620 to a state 630 to a state 640 to a state 650, an electronic device 110 may display UI of a game application through a display 113. For example, the UI may include a designated area 250. The electronic device 110 may display slots within the designated area 250. The slots may include a first group of slots 251 and a second group of slots 252.

In the state 610, the first group of slots 251 may be displayed based on a plurality of pages. The first group of slots 251 may be displayed based on one of the plurality of pages. The first group of slots 251 may be slots included in the one of the plurality of pages. For example, the electronic device 110 may display an object 501 representing a page of the first group of slots 251 within the designated area 250.

For example, the second group of slots 252 may be in a fixed state. The electronic device 110 may maintain displaying the second group of slots 252 regardless of an input for changing a page related to the first group of slots 251. For example, the electronic device 110 may display an object 502 representing that slots of the second group of slots 252 are in the fixed state within the designated area 250.

For example, the first group of slots 251 may include slots 251-1. The slots 251-1 may be included in the first group of slots 251.

According to one or more embodiments, the electronic device 110 may display a divider 611 for distinguishing the first group of slots 251 and the second group of slots 252. According to one or more embodiments, the electronic device 110 may not display the divider 611. For example, the electronic device 110 may display the divider 611 in an area based on an input (e.g., a touch input, or a click input) on the area between the first group of slots 251 and the second group of slots 252.

In the state 620, the electronic device 110 may identify an input for moving the divider 611. For example, the electronic device 110 may identify a drag input 612 with respect to the divider 611. For example, the electronic device 110 may identify an input for moving the divider 611 along a direction 614.

For example, the electronic device 110 may display the divider 611 based on the input on the area between the first group of slots 251 and the second group of slots 252, and move the divider 611 based on the drag input 612 following from the input on the area.

According to one or more embodiments, the electronic device 110 may display a visual object 613 for representing movement of the divider 611 based on the input for moving the divider 611. For example, the electronic device 110 may display the visual object 613 in response to the drag input 612 starting on the divider 611. For example, the electronic device 110 may display the changed visual object 613 within the designated area 250. According to one or more embodiments, the electronic device 110 may display the changed visual object 613 outside the designated area 250.

In the state 630, the electronic device 110 may move the divider 611 along the direction 614 based on the drag input 612. For example, the electronic device 110 may change the visual object 613 based on moving the divider 611. For example, the electronic device 110 may extend the visual object 613 along the direction 614. The visual object 613 may extend along the direction 614.

For example, the visual object 613 may represent a direction of the drag input 612. According to one or more embodiments, the visual object 613 may be formed along the direction 614 in an arrow direction.

For example, as the divider 611 is moved, the electronic device 110 may display the divider 611 by overlapping the slots 251-1 of the first group of slots 251. The electronic device 110 may move the divider 611 along the drag input 612 on the slots 251-1.

In the state 640, the electronic device 110 may position the divider 611 on a left side of the slots 251-1 based on the drag input 612. The electronic device 110 may identify that the input (e.g., the drag input 612) for moving the divider 611 is released in a state that the divider 611 is positioned on the left side of the slots 251-1. The electronic device 110 may fix the position of the divider 611 based on the input for moving the divider 611 being released.

The state 650 may represent a state in which the drag input 521 illustrated in the state 640 is released. For convenience of explanation, in the state 650, the drag input 521 illustrated in the state 640 may be referred.

In the state 650, the electronic device 110 may change a group of the slots 251-1 from the first group to the second group based on the position of the divider 611 being fixed to the left side of the slots 251-1. The electronic device 110 may change the number of the first group of slots 251 based on the group of the slots 251-1 being changed from the first group to the second group.

For example, the electronic device 110 may change the slots 251-1 included in the first group of slots 251 to the second group based on the drag input 612. Based on the drag input 612, the slots 251-1 may be excluded from the first group. Based on the drag input 612, the slots 251-1 may be included in the second group of slots 252.

According to one or more embodiments, the electronic device 110 may change the number of the first group of slots to be changed by a second input (e.g., an input for changing the page) based on the input for moving the divider 611. For example, the electronic device 110 may change the number of the first group of slots 251 from 30 to 24, based on the drag input 612. For example, the electronic device 110 may change the number of slots included in each of the plurality of pages related to the first group of slots 251 from 10 to 8, based on the drag input 612.

The electronic device 110 may change the number of the second group of slots to be changed by the second input (e.g., the input for changing the page), based on the input (e.g., the drag input 612) for moving the divider 611. For example, the electronic device 110 may change the number of the second group of slots 252 from 8 to 10, based on the input for moving the divider 611.

According to one or more embodiments, the electronic device 110 may not display the divider 611 based on changing the number of the first group of slots 251 according to the movement of the divider 611. For example, the electronic device 110 may display the divider 611 based on an input on a left side area (i.e., the area between the first group of slots 251 and the second group of slots 252) of the slots 251-1.

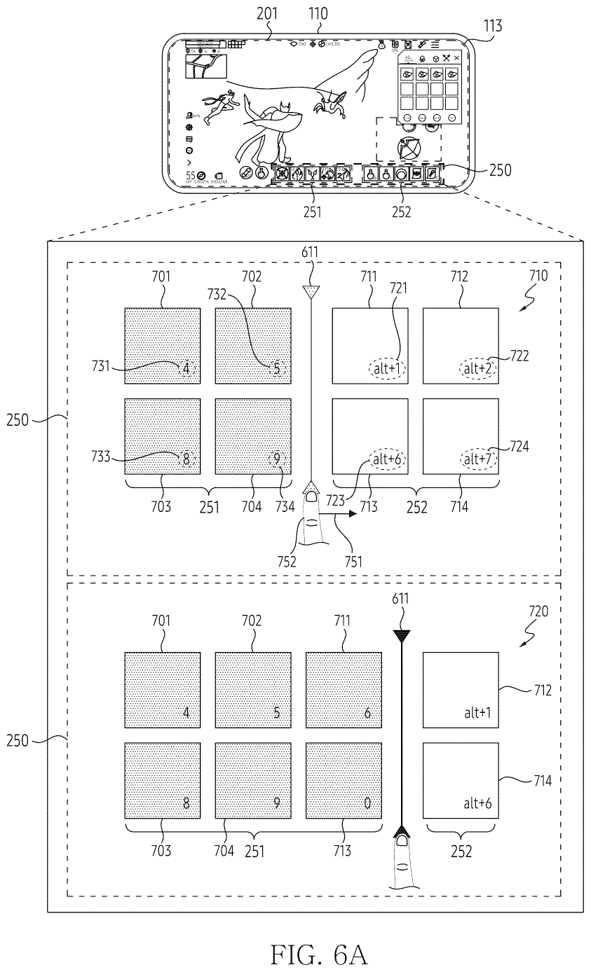

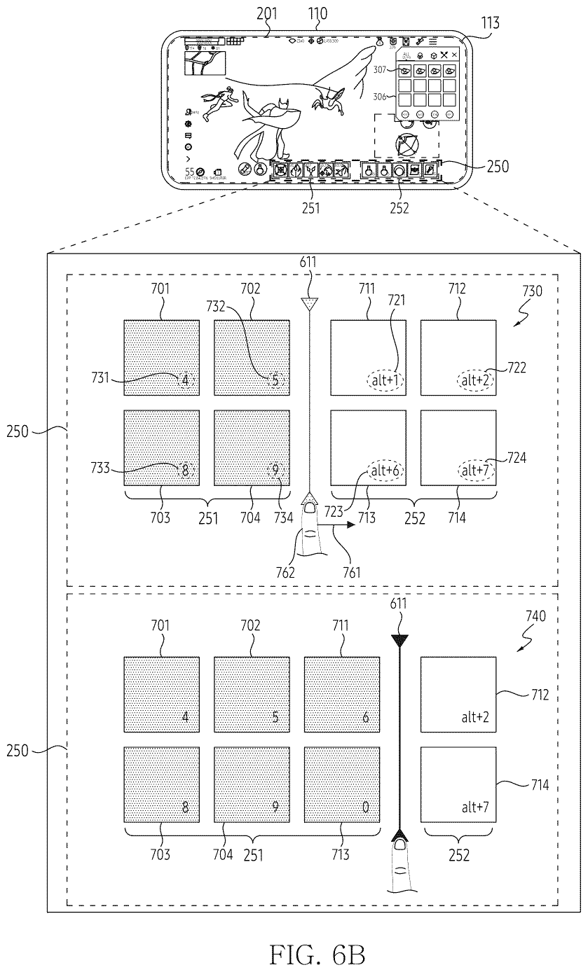

FIGS. 6A and 6B illustrate an example of slots displayed within a designated area according to one or more embodiments.

Referring to FIG. 6A, in a state 710 and a state 720, the electronic device 110 may display UI 201 of a game application through a display 113. For example, the UI 201 may include a designated area 250. The electronic device 110 may display slots within the designated area 250. The slots may include a first group of slots 251 and a second group of slots 252.

In the state 710, the first group of slots 251 may be displayed based on a plurality of pages. The first group of slots 251 may be displayed based on one of the plurality of pages. The first group of slots 251 may be slots included in the one of the plurality of pages.

For example, the second group of slots 252 may be in a fixed state. The electronic device 110 may maintain displaying the second group of slots 252 regardless of an input for changing a page related to the first group of slots 251.

For example, the first group of slots 251 may include a slot 701, a slot 702, a slot 703, and a slot 704. For example, the second group of slots 252 may include a slot 711, a slot 712, a slot 713, and a slot 714.

According to one or more embodiments, functions allocated to the first group of slots 251 may be executed based on a first type of shortcut key input. For example, the electronic device 110 may execute the functions allocated to the first group of slots 251 based on an input of a number key. The electronic device 110 may display, in the first group of slots 251, a shortcut key allocated to each of the first group of slots 251.

As an example, the slot 701 of the first group of slots 251 may be executed based on an input on a number key ‘4’. The electronic device 110 may display an object 731 representing the number key ‘4’ in the slot 701. The slot 702 of the first group of slots 251 may be executed based on an input on a number key ‘5’. The electronic device 110 may display an object 732 representing the number key ‘5’ in the slot 702. The slot 703 of the first group of slots 251 may be executed based on an input on a number key ‘8’. The electronic device 110 may display an object 733 representing the number key ‘8’ in the slot 703. The slot 704 of the first group of slots 251 may be executed based on an input on a number key ‘9’. The electronic device 110 may display an object 734 representing the number key ‘9’ in the slot 704.

According to one or more embodiments, functions allocated to the second group of slots 252 may be executed based on a second type of shortcut key input. For example, the electronic device 110 may execute the functions allocated to the second group of slots 252 based on an input of a special key and the number key. The electronic device 110 may display, in the second group of slots 252, a shortcut key allocated to each of the second group of slots 252.

For example, the slot 711 of the second group of slots 252 may be executed based on an input on a special key ‘alt’ and a number key ‘1’. The electronic device 110 may display an object 721 representing the special key ‘alt’ and the number key ‘1’ in the slot 711. The slot 712 of the second group of slots 252 may be executed based on an input on the special key ‘alt’ and a number key ‘2’. The electronic device 110 may display an object 722 representing the special key ‘alt’ and the number key ‘2’ in the slot 712. The slot 713 of the second group of slots 252 may be executed based on an input on the special key ‘alt’ and a number key ‘6’. The electronic device 110 may display an object 723 representing the special key ‘alt’ and the number key ‘6’ in the slot 713. The slot 714 of the second group of slots 252 may be executed based on an input on the special key ‘alt’ and a number key ‘7’. The electronic device 110 may display an object 724 representing the special key ‘alt’ and the number key ‘7’ in the slot 714.

According to one or more embodiments, the electronic device 110 may display a divider 611 for distinguishing the first group of slots 251 and the second group of slots 252. According to one or more embodiments, the electronic device 110 may not display the divider 611. For example, the electronic device 110 may display the divider 611 in an area based on an input (e.g., a touch input, or a click input) on the area between the first group of slots 251 and the second group of slots 252.

For example, the electronic device 110 may identify a drag input 752 as an input for moving the divider 611. The electronic device 110 may identify the drag input 752 in a direction 751.

The state 720 may represent a state in which the drag input 752 illustrated in the state 710 is released. For convenience of explanation, in the state 720, the drag input 752 illustrated in the state 710 may be referred.

In the state 720, the electronic device 110 may identify that the divider 611 is positioned between a first area corresponding to the slot 711 and the slot 713, and a second area corresponding to the slot 714. For example, the electronic device 110 may change the number of the first group of slots 251 based on the drag input 752, which is the input for moving the divider 611. The electronic device 110 may increase the number of the first group of slots 251. The electronic device 110 may change a group of the slot 711 and the slot 713 from the second group to the first group.

According to one or more embodiments, the electronic device 110 may execute at least one function allocated to at least one of the first group of slots 251 based on the second type of shortcut key input, based on an input (or a third input) for changing the number of the first group of slots 251.

For example, the electronic device 110 may change a shortcut key for executing a function of the slot 711 and the slot 713, based on the group of the slot 711 and the slot 713 being changed from the second group to the first group. As an example, the electronic device 110 may change a shortcut for executing the function of the slot 711 from a combination of the special key ‘alt’ and the number key ‘1’ to the number key ‘6’, based on a group of the slot 711 being changed from the second group to the first group. As an example, the electronic device 110 may change a shortcut key for executing the function of the slot 713 from a combination of the special key ‘alt’ and the number key ‘6’ to the number key ‘0’, based on a group of the slot 713 being changed from the second group to the first group.

According to one or more embodiments, the electronic device 110 may also change a shortcut key for executing a function of the slot 712 and the slot 713, based on the group of the slot 711 and the slot 713 being changed from the second group to the first group. For example, the electronic device 110 may change a shortcut key for executing the function of the slot 712 from a combination of the special key ‘alt’ and the number key ‘2’ to a combination of the special key ‘alt’ and the number key ‘1’, based on the group of the slot 711 and the slot 713 being changed from the second group to the first group. For example, the electronic device 110 may change a shortcut key for executing the function of the slot 714 from a combination of the special key ‘alt’ and the number key ‘7’ to a combination of alt′ and the number key ‘6’, based on the group of the slot 711 and the slot 713 being changed from the second group to the first group.

Referring to FIG. 6B, a state 730 may correspond to the state 710 of FIG. 6A. In the state 730, the electronic device 110 may identify a drag input 762, which is an input for moving the divider 611. The electronic device 110 may identify the drag input 762 in a direction 761.

The state 740 may represent a state in which the drag input 762 illustrated in the state 730 is released. For convenience of explanation, in the state 740, the drag input 762 illustrated in the state 730 may be referred.

In the state 740, the electronic device 110 may identify that the divider 611 is positioned between the first area corresponding to the slot 711 and the slot 713 and the second area corresponding to the slot 714. For example, the electronic device 110 may change the number of the first group of slots 251 based on the drag input 762, which is the input for moving the divider 611. The electronic device 110 may increase the number of the first group of slots 251. The electronic device 110 may change the group of the slot 711 and the slot 713 from the second group to the first group.

According to one or more embodiments, the electronic device 110 may execute at least one function allocated to at least one of the first group of slots 251 based on the second type of shortcut key input, based on the input (or the third input) for changing the number of the first group of slots 251.

For example, the electronic device 110 may change a shortcut key for executing the function of the slot 711 and the slot 713, based on the group of the slot 711 and the slot 713 being changed from the second group to the first group. The electronic device 110 may change a shortcut key for executing the function of the slot 711 and the slot 713 in the same or similar manner as in FIG. 6A.

Unlike FIG. 6A, the electronic device 110 may maintain a shortcut key for executing the function of the slot 712 and the slot 713, based on the group of the slot 711 and the slot 713 being changed from the second group to the first group. Even when the group of the slot 711 and the slot 713 is changed from the second group to the first group, the electronic device 110 may maintain the shortcut key for executing the function of the slot 712 and the slot 713. For example, the electronic device 110 may maintain a shortcut for executing the function of the slot 712 as a combination of the special key ‘alt’ and the number key ‘2’. For example, the electronic device 110 may maintain the shortcut for executing the function of the slot 714 as a combination of the special key ‘alt’ and the number key ‘7’.

According to one or more embodiments, an electronic device may comprise a display, memory storing instructions, and at least one processor operably coupled to the display and the memory, and the at least one processor, when executing the instructions, may be configured to display the designated number of slots within a designated area of the display, based on a first input, execute at least one of functions allocated to the designated number of slots, based on a second input, change a first group of slots among the designated number of slots, and maintain displaying a second group of slots distinct from the first group of slots within the designated area, and based on a third input, change the number of the first group of slots to be changed by the second input.

According to one or more embodiments, the third input may be identified by a drag input for moving a divider displayed between the first group of slots and the second group of slots.

According to one or more embodiments, the at least one processor, when executing the instructions, may be further configured to, based on an input on an area between the first group of slots and the second group of slots, display the divider, and based on the drag input following from the input on the area, move the divider.

According to one or more embodiments, the third input may be identified by an input for changing at least one slot of the first group of slots to the second group of slots.

According to one or more embodiments, the at least one processor, when executing the instructions, may be further configured to identify an input on the at least one slot of the first group of slots, based on the input on the at least one slot of the first group of slots, display a visual object for representing movement of the at least one slot of the first group of slots, and based on a drag input following from the input on the at least one slot of the first group of slots, change the at least one slot of the first group of slots to the second group of slots.

According to one or more embodiments, the first input may be identified based on an input on one of shortcut keys corresponding to the designated number of slots.

According to one or more embodiments, functions allocated to the first group of slots may be executed based on a first type of shortcut key input, and functions allocated to the second group of slots may be executed based on a second type of shortcut key input distinct from the first type of shortcut key input.

According to one or more embodiments, the at least one processor, when executing the instructions, may be further configured to, based on the third input, execute, based on the second type of shortcut key input, at least one function allocated to the at least one slot of the first group of slots.

According to one or more embodiments, the at least one processor, when executing the instructions, may be further configured to display the first group of slots based on a plurality of pages, identify the second input while one of the plurality of pages is displayed, and based on the second input, change the first group of slots by changing the one of the plurality of pages to another page.

According to one or more embodiments, the at least one processor, when executing the instructions, may be further configured to display a first visual object for representing the plurality of pages in conjunction with the first group of slots, and display a second visual object for representing that the second group of slots are in a fixed state in conjunction with the second group of slots.

According to one or more embodiments, a method of an electronic device may comprise displaying the designated number of slots within a designated area of a display of the electronic device, based on a first input, executing at least one of functions allocated to the designated number of slots, based on a second input, changing a first group of slots among the designated number of slots, and maintain displaying a second group of slots distinct from the first group of slots within the designated area, and based on a third input, changing the number of the first group of slots to be changed by the second input.

According to one or more embodiments, the third input may be identified by a drag input for moving a divider displayed between the first group of slots and the second group of slots.

According to one or more embodiments, the method may further comprise, based on an input on an area between the first group of slots and the second group of slots, displaying the divider, and based on the drag input following from the input on the area, moving the divider.

According to one or more embodiments, the third input may be identified by an input for changing at least one slot of the first group of slots to the second group of slots.

According to one or more embodiments, the method may further comprise identifying an input on the at least one slot of the first group of slots, based on the input on the at least one slot of the first group of slots, displaying a visual object for representing movement of the at least one slot of the first group of slots, and based on a drag input following from the input on the at least one slot of the first group of slots, changing the at least one slot of the first group of slots to the second group of slots.

According to one or more embodiments, the first input may be identified based on an input on one of shortcut keys corresponding to the designated number of slots.

According to one or more embodiments, functions allocated to the first group of slots may be executed based on a first type of shortcut key input, and functions allocated to the second group of slots may be executed based on a second type of shortcut key input distinct from the first type of shortcut key input.

According to one or more embodiments, the method may further comprise, based on the third input, execute, based on the second type of shortcut key input, at least one function allocated to the at least one slot of the first group of slots.

According to one or more embodiments, the method may further comprise displaying the first group of slots based on a plurality of pages, identifying the second input while one of the plurality of pages is displayed, and based on the second input, changing the first group of slots by changing the one of the plurality of pages to another page.

According to one or more embodiments, a computer readable storage media may store one or more programs. The one or more programs may include instructions which, when executed by at least one processor of an electronic device with a display, cause the electronic device to display the designated number of slots within a designated area of the display, based on a first input, execute at least one of functions allocated to the designated number of slots, based on a second input, change a first group of slots among the designated number of slots, and maintain displaying a second group of slots distinct from the first group of slots within the designated area, and based on a third input, change the number of the first group of slots to be changed by the second input.

Methods according to embodiments described in claims or specifications of the present disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the present disclosure.

Such a program (software module, software) may be stored in a random access memory, a non-volatile memory including a flash memory, a ROM, an EEPROM, a magnetic disc storage device, an optical storage device (e.g., a CD-ROM, digital versatile discs (DVDs), or other formats), a magnetic cassette or memory configured with a combination thereof. Alternatively, it may be stored in memory configured with a combination of some or all of them. In addition, a plurality of configuration memories may be included. Additionally, a program may be stored in an attachable storage device that may be accessed through a communication network such as the Internet, Intranet, LAN, WAN, or storage area network (SAN), or a combination thereof. Such a storage device may be connected to a device performing one or more embodiments of the present disclosure through an external port. In addition, a separate storage device on the communication network may also be connected to a device performing one or more embodiments of the present disclosure.

In the above-described specific embodiments of the present disclosure, components of the electronic device included in the disclosure are expressed in the singular or plural according to the presented specific embodiment. However, the singular or plural expression for the components is selected appropriately according to a situation presented for convenience of explanation, and the present disclosure is not limited to the singular or plural component, and even components expressed in the plural may be configured in the singular, or a component expressed in the singular may be configured in the plural.

Meanwhile, specific embodiments have been described in the detailed description of the present disclosure, and of course, various modifications are possible without departing from the scope of the present disclosure. Therefore, the scope of the present disclosure should not be limited to the described embodiments, but should be defined not only by the scope of the claims described below but also by equivalents of the claims.

What is claimed is:

1. An electronic device comprising:
a display;
memory storing instructions; and
at least one processor operably coupled to the display and the memory,
wherein the at least one processor, when executing the instructions, is configured to:
display a designated number of slots within a designated area of the display;
based on a first input, execute at least one of functions allocated to the designated number of slots;
based on a second input, change, within the designated area, a first group of slots among the designated number of slots from a first plurality of the slots and to a second plurality of the slots, and maintain displaying, on the display, a second group of slots distinct from the first group of slots within the designated area both before and after changing the first group of slots from the first plurality of the slots to the second plurality of the slots; and
based on a third input, change a number of slots of the first group of slots from a first number of slots to a second number of slots.

2. The electronic device of claim 1, wherein the third input is identified by a drag input moving a divider displayed within the designated area and between the first group of slots and the second group of slots.

3. The electronic device of claim 2, wherein the at least one processor, when executing the instructions, is further configured to:
based on an input to an area within the designated area and between the first group of slots and the second group of slots, display the divider; and
based on the drag input following from the input on the area, move the divider.

4. The electronic device of claim 1, wherein the third input is identified as an input indicating to change at least one slot of the first group of slots from the first group of slots and to the second group of slots.

5. The electronic device of claim 4, wherein the at least one processor, when executing the instructions, is further configured to:
identify an input indicating the at least one slot of the first group of slots;
based on identifying the input indicating the at least one slot of the first group of slots, display a visual object representing movement of the at least one slot of the first group of slots; and
based on a drag input following from the input indicating the at least one slot of the first group of slots, change the at least one slot of the first group of slots to the second group of slots.

6. The electronic device of claim 5, wherein the first input is identified based on an input of one of shortcut keys preset to ones of the designated number of slots.

7. The electronic device of claim 6, wherein one or more first functions allocated to the first group of slots are executed based on a first type of shortcut key input of the input of the one of the shortcut keys, the one or more first functions allocated to the first group of slots are first ones of the functions allocated to the designated number of slots, and
wherein one or more second functions allocated to the second group of slots are executed based on a second type of shortcut key input distinct from the first type of shortcut key input, the one or more second functions allocated to the second group of slots are second ones of the functions allocated to the designated number of slots.

8. The electronic device of claim 7, wherein the at least one processor, when executing the instructions, is further configured to:
based on the third input and on identifying the second type of shortcut key input as being input, execute at least one function allocated to the at least one slot changed from the first group of slots to the second group of slots.

9. The electronic device of claim 1, wherein the at least one processor, when executing the instructions, is further configured to:
display the first group of slots as one of a plurality of pages of the first group of slots;
identify the second input while one of the plurality of pages is displayed; and
based on the second input, change the first group of slots by changing the one of the plurality of pages to another page of the plurality of pages.

10. The electronic device of claim 9, wherein the at least one processor, when executing the instructions, is further configured to:
display a first visual object representing the plurality of pages in conjunction with the first group of slots; and
display a second visual object representing that the second group of slots are in a fixed state in conjunction with the second group of slots.

11. A method of an electronic device, the method comprising:
displaying a designated number of slots within a designated area of a display of the electronic device;
based on a first input, executing at least one of functions allocated to the designated number of slots;
based on a second input, changing, within the designated area, a first group of slots among the designated number of slots from a first plurality of the slots to a second plurality of the slots, and maintain displaying, on the display, a second group of slots distinct from the first group of slots within the designated area both before and after changing the first group of slots from the first plurality of the slots to the second plurality of the slots; and
based on a third input, changing a number of slots of the first group of slots from a first number of slots to a second number of slots.

12. The method of claim 11, wherein the third input is identified by a drag input moving a divider displayed within the designated area and between the first group of slots and the second group of slots.

13. The method of claim 12, further comprising:
based on an input to an area within the designated area and between the first group of slots and the second group of slots, displaying the divider; and
based on the drag input following from the input on the area, moving the divider.

14. The method of claim 11, wherein the third input is identified as an input indicating to change at least one slot of the first group of slots from the first group of slots and to the second group of slots.

15. The method of claim 14, further comprising:
identifying an input indicating the at least one slot of the first group of slots;
based on identifying the input indicating the at least one slot of the first group of slots, displaying a visual object representing movement of the at least one slot of the first group of slots; and
based on a drag input following from the input indicating the at least one slot of the first group of slots, changing the at least one slot of the first group of slots to the second group of slots.

16. The method of claim 15, wherein the first input is identified based on an input of one of shortcut keys present to ones of the designated number of slots.

17. The method of claim 16, wherein one or more first functions allocated to the first group of slots are executed based on a first type of shortcut key input of the input of the one of the shortcut keys, the one or more first functions allocated to the first group of slots are ones of the functions allocated to the designated number of slots, and
wherein one or more second functions allocated to the second group of slots are executed based on a second type of shortcut key input distinct from the first type of shortcut key input, the one or more second functions allocated to the second group of slots are second ones of the functions allocated to the designated number of slots.

18. The method of claim 17, further comprising:
based on the third input and on identifying the second type of shortcut key input as being input, execute at least one function allocated to the at least one slot of the first group of slots.

19. The method of claim 11, further comprising:
displaying the first group of slots as one of on a plurality of pages of the first group of slots;
identifying the second input while one of the plurality of pages is displayed; and
based on the second input, changing the first group of slots by changing the one of the plurality of pages to another page of the plurality of pages.

20. A non-transitory computer readable storage media storing one or more programs, wherein the one or more programs includes instructions which, when executed by at least one processor of an electronic device with a display, cause the electronic device to:
display a designated number of slots within a designated area of the display;
based on a first input, execute at least one of functions allocated to the designated number of slots;
based on a second input, change, within the designated area, a first group of slots among the designated number of slots from a first plurality of the slots to a second plurality of the slots, and maintain displaying, on the display, a second group of slots distinct from the first group of slots within the designated area both before and after changing the first group of slots from the first plurality of the slots to the second plurality of the slots; and
based on a third input, change a number of slots of the first group of slots from a first number of slots to a second number of slots.
